(19) United States
(12) Patent Application Publication
(10) Pub. No.: US 2006/0109223 A1
(43) Pub. Date: May 25, 2006

(54) DISPLAY WITH IMPROVED COLOR DEPTH AND METHOD THEREOF

(76) Inventor: Chien-Sheng Yang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,998

(22) Filed: Mar. 15, 2005

(30) Foreign Application Priority Data
Nov. 24, 2004 (TW) 093136200

(51) Int. Cl. G09G 3/36

(52) U.S. Cl. 345/89

(57) ABSTRACT

A display includes a display device and a logic processing unit. The logic processing unit is formed on the display panel to transform a gray value of an original data into the gray value of a display data.

### BACKGROUND OF INVENTION

1. Field of the Invention

The invention relates to a flat display and a method thereof, and more particularly, to a flat display and a method which integrate a logic processing unit into a flat display panel and increase the color display levels with limited bits.

2. Description of the Prior Art

Flat displays are widely utilized in portable information products, such as laptop computers, personal digital assistants (PDAs), flight devices, or medical electronic devices owing to the advantages of small volume, lightweight, low power consumption, and no radiation.

Please refer to FIG. 1, a liquid crystal display (LCD) 10 according to the prior art is shown. The LCD 10 comprises a display area 12, which comprises a plurality of scan lines and a plurality of data lines (not shown in FIG. 1), a gate driver (scan driver) 14, a data driver 16 for respectively driving the scan lines and data lines in the display area 12, and an external data processing circuit 18 for receiving input image data (such as red image signal 21, green image signal 22, and blue image signal 23 shown in FIG. 1) from a system and generating corresponding output image data (such as red image data 24, green image data 25, and blue image data 26 shown in FIG. 1). As known by those skilled in the art, the gate driver 14 comprises a plurality of gate driving IC chips 15A, 15B, 15C to provide a turn-on voltage to corresponding scan lines. The data driver 16 comprises a plurality of source driving IC chips 17A, 17B, 17C to respectively provide a gray scale voltage corresponding to an image signal to each data line. The data processing 18 comprises a timing controller 20 for controlling the timing operations of the gate driving IC chips 15A, 15B, 15C and the source driving IC chips 17A, 17B, 17C according to a vertical synchronous signal VSYNC 27, a horizontal synchronous signal HSYNC 28, and a driving clock CLOCK 29.

Please refer to FIG. 1 again. After the buffer memories inside the source driving IC chip 17A fill with image data, the next source driving IC chip 17B starts to grab image data until the buffer memories inside the source driving IC chip 17B are filled. The above steps are repeated until all the source driving IC chips 17A, 17B, 17C are filled. This means that the above steps are repeated until data of a scan line are all written in corresponding source IC chips. Then, the timing controller 20 controls all source driving IC chips 17A, 17B, 17C. Therefore, data stored in the buffer memories of the source driving IC chips 17A, 17B, 17C are outputted into a digital/analog converter (not shown). Finally, each D/A converter transforms the digital image data into analog voltage signals and outputs the analog voltage signals to the display area 12 so that corresponding data lines are triggered.

In the prior art, because of the limited space of the chip, the D/A converter of a normal low temperature poly-silicon (LTPS) TFT-LCD can only process 12-bit gray value or 16-bit gray value. If an n-bit gray value (where n is greater than 16) has to be processed, a better OP-amp or a better analog buffer has to be utilized in a high-speed D/A converter to meet the demands. In today's technology of LTPS producing processes, however, the high speed D/A converter are not produced quickly and stably.

### SUMMARY OF INVENTION

It is therefore one of the objectives of the claimed invention to provide a display integrating a logic processing unit on the displaying device, and utilizing limited bits to increase color display levels, in order to solve the above-mentioned problem.

According to an exemplary embodiment of the claimed invention, a display is disclosed. The display comprises: a substrate; a plurality of pixels formed on the substrate; and a logic processing unit formed on the substrate for performing a calculation on a gray value of an input data as a gray value of a display data.

Furthermore, a method for manufacturing a display is disclosed. The method comprises: providing a substrate; forming a plurality of pixels on the substrate; and forming a logic processing unit on the substrate for performing a calculation on a gray value of an input data as a gray value of a display data.

The present invention can utilize a DA converter to process 12-bit gray values to display a higher bit (such as 18-bit) gray value without additional circuits. This not only saves costs, but also provides another solution of a high-level image display.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an illustration of a liquid crystal display according to the prior art.

FIG. 2 is a diagram of a liquid crystal display of a first embodiment according to the present invention.

FIG. 3 is a flow chart illustrating that the liquid crystal display shown in FIG. 2 processes image data.

FIG. 4 is a diagram of a liquid crystal display of a second embodiment according to the present invention.

### DETAILED DESCRIPTION

The present invention display utilizes the vision-mistaken phenomenon. For example, considering an image data having 3-bit gray value, each pixel can display gray values (a 3-bit number such as 0, 1, 2, 3, 4, 5, 6, 7), where each gray value represents a voltage level of a pixel (or a liquid crystal unit) so that the pixel can display different luminance. But in another system, which allows 4-bit gray value, the gray value can have 16 different values (such as 0, 1, 2, 3, 4, 5, 6, 7, 8, 9, 10, 11, 12, 13, 14, 15). Therefore, the present invention display can utilize the vision-mistaken phenomenon to display an overlap of 3-bit image data. For example, a pixel overlaps a display of a gray value 3 and another gray value 4 and a human feels the gray value as 3.5 (the average of 3 and 4) instead of current values 3 and 4. Therefore, the displayed bit number is “virtually” increased through the above-mentioned operation.

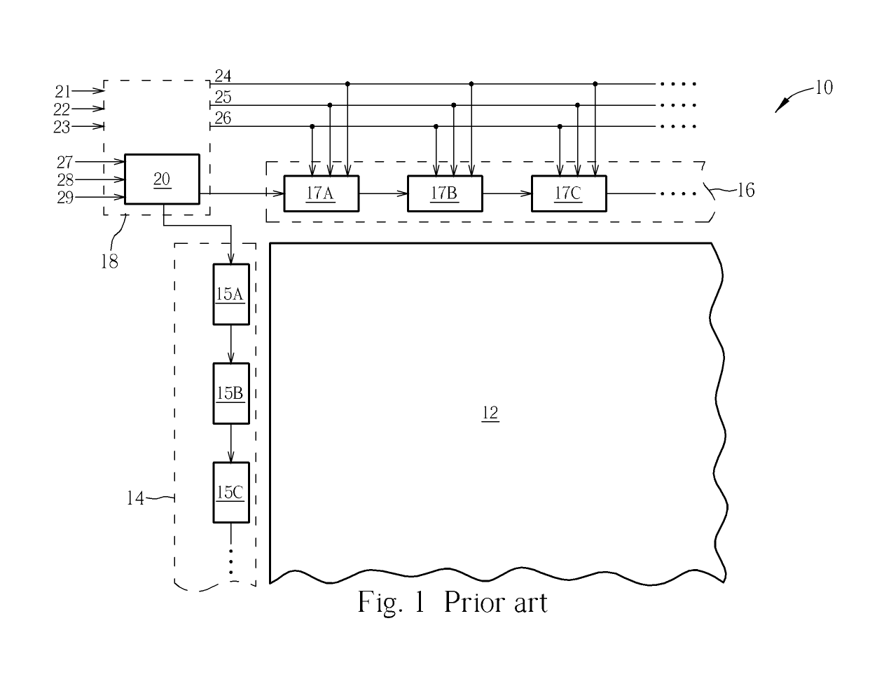

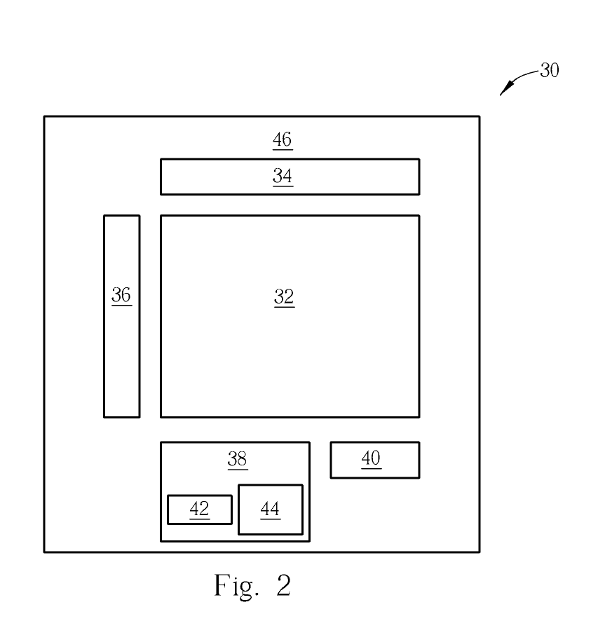

Please refer to FIG. 2, which is a diagram of a liquid crystal display 30 of a first embodiment according to the present invention. As shown in FIG. 2, the LCD 30 comprises a display area 32, a gate driver 36 and a data driver 34 for driving scan lines and data lines (not shown) of the display area 32, a logic processing unit 38, and an I/F circuit 40. Please note that devices having the same name in FIG. 1 and FIG. 2 have the same function and operation, and are thus omitted here. The I/F circuit 40 known by those skilled in the art, is utilized to receive the input image data and transfer the input image data to the logic processing unit 38. In the end, the logic processing unit 38 outputs corresponding output image data. Please note that in this embodiment, the logic processing unit 38, the display area 32, the gate driver 36, and the data driver 34 can be produced on the same substrate 46 through the low temperature poly-solicon (LTPS). As mentioned above, this structure can make the hardware more consistent. Furthermore, the logic processing unit 38 comprises an adder 42 and a timing controller 44. The operation of the adder 42 and the timing controller 44 are illustrated in the following disclosure.

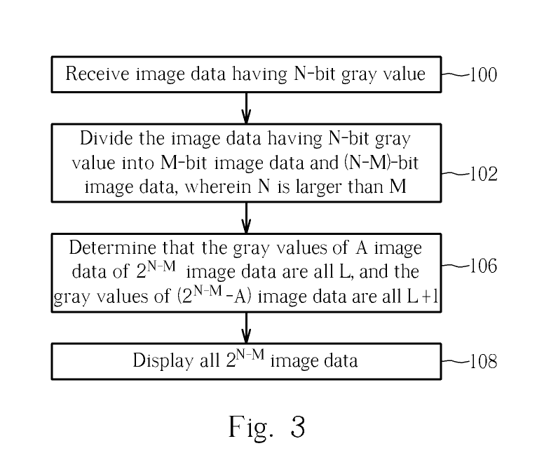

Please refer to FIG. 3, which is a flow chart illustrating that the liquid crystal display 30 shown in FIG. 2 processes images data. The operation comprises the following steps:

Step 100: Receive image data having N-bit gray value;

Step 102: Divide the image data having N-bit gray value into M-bit image data (an image data having M-bit gray value) and a (N−M)-bit image data, wherein N is larger than M;

Step 106: Determine that the gray values of A image data of 2 ^{N-M} image data are all L, and the gray values of the other image data (2^{N-M}-A image data) are all L+1; and

Step 108: Display all 2^{N-M} image data.

For example, the logic processing unit 38 receives a 4-bit image data (N=4) whose gray value is 13_{decimal} from the I/F circuit 40 (step 100). Assuming that the D/A converter can only process a 3-bit image data (M=3), in this embodiment, the gray value 13 can be regarded as a binary number 1101_{binary}. Therefore, the timing controller 44 divides the 4-bit image data into a gray value 3-bit data 110_{binary} (represented in a binary number) and an indicating data 1 (represented in a binary number). Then, the timing controller 44 transfers the 3-bit image data 110_{binary} to the data driver 36 to drive the LCD panel (display area) 32 and outputs a control signal to the adder 42 according to the indicating data 1_{binary}. Here, because the indicating data is a 1-bit data 1_{binary}, it represents that the LCD 30 has to process 1 frame (corresponding to the 1-bit data 1) of 2 frames (corresponding to 2^{N-M}=2¹). Therefore, the adder 42 performs an adding calculation on the 3-bit image data (110+1=111) when receiving a control signal, and then the timing controller 44 transfers the adjusted 3-bit image data 111 to the data driver 36 in order to drive the display area 32. Therefore, in two adjacent frames, a pixel overlaps the gray values 110_{binary}, 111_{binary}. As mentioned above, a human will feel the gray value as 6.5_{decimal} instead of individual 6_{decimal} (110)_{binary} and 7_{decimal} (111)_{binary}. In other words, users can experience a better display level of the LCD 30.

Please note that the bit number of the LCD 30 is not limited. Here, another example is disclosed for a further illustration. Assume that the LCD 30 has to display an image data whose gray value is 27_{decimal} (11011_{binary}) but the LCD only has the D/A converter, which only can process 3-bit image data. Therefore, the timing controller 44 firstly divides the image data into a 3-bit gray value data 110_{binary} and a 2-bit indicating data 11_{binary}, and then transfers the 3-bit image data to the data driver 36 to drive the LCD panel 32 and outputs a control signal to the adder 42. Here, because the indicating data is a 2-bit data 3_{decimal}, this represents that the LCD 30 has to process 3 frames (corresponding to the indicating data 3_{decimal}) out of 4 frames (corresponding to 2^{N-M}=2²=4). Therefore, the adder 42 performs an adding calculation on the 3-bit image data (110+1=111), and then the timing controller 44 transfers the adjusted 3-bit image data 111 to the data driver 36 to drive the LCD panel 32. Therefore, in 4 adjacent frames, a pixel displays the gray value 111 in 3 frames and displays the gray value 110 in 1 frame. As mentioned above, because a pixel displays 6_{decimal} (110_{binary}), 7_{decimal} (111_{binary}), 7_{decimal} (111_{binary}), 7_{decimal} (111_{binary}) a human will feel the gray value as 6.75_{decimal}.

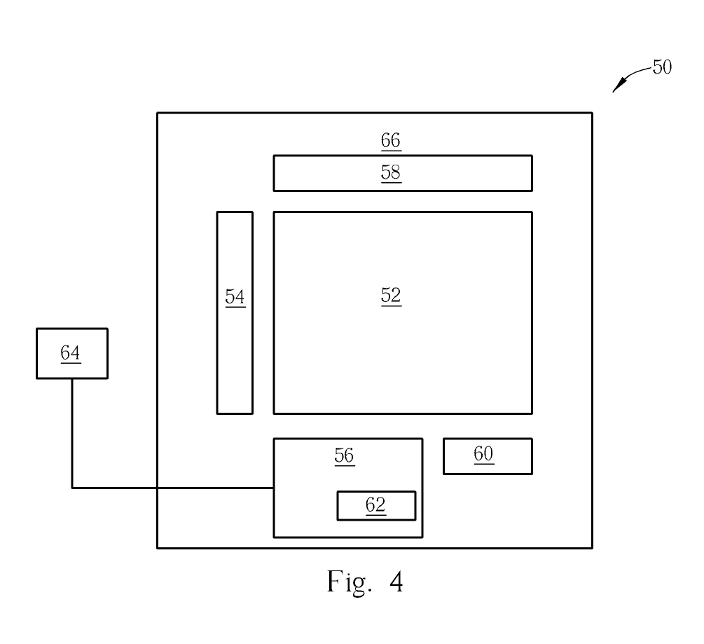

Please refer to FIG. 4, which is a diagram of a liquid crystal display 50 of a second embodiment according to the present invention. As shown in FIG. 4, the LCD 50 comprises a display area 52, a gate driver 54 and a data driver for driving the scan lines and data lines (not shown) of the display area 32, a logic processing unit 58, and an I/F circuit 60. Please note that the devices having the same name in FIG. 4 and FIG. 2 have the same function and operation, and thus are omitted here. Please also note that the logic processing unit 58, the display area 52, the gate driver 54, and the data driver 56 can be produced on the same substrate 66 through a LTPS producing process. As mentioned above, this makes the hardware more consistent. Furthermore, the difference between the logic processing unit 58 and the logic processing unit 38 shown in FIG. 2 is that the logic processing unit 58 only comprises an adder 62. The timing controller 64 is not formed on the substrate 66.

Please note that the present invention glass substrate (because the LCD panel often utilizes the glass substrate as the substrate) is only utilized as an illustration for a preferred embodiment and is not a limitation. In fact, an electro-migration light emitting display panel can also be embodied, such as an organic light emitting display panel. Furthermore, the present invention adder can perform a normal adding calculation (that is it adds +1 or 0 on the gray value of the original signal). But in fact, the adder can also perform a complement adding calculation (that is it adds −1 on the gray value of the original signal). This also obeys the spirit of the present invention.

Please note that in the above-mentioned embodiment, the pixels are organic electro luminescent light emitting pixels. But in fact, other materials can also be utilized for the pixels. For example, the pixels can be liquid crystal controlled light valves. This also obeys the spirit of the present invention. In other words, the organic electro luminescent light emitting pixels are only utilized for an illustration, not a limitation of the present invention.

In contrast to the prior art, the present invention LCD and manufacturing method thereof can produce the LCD panel and the logic processing unit on the same substrate. Therefore, the ICs can be directly formed on the LCD panel so that the space originally occupied by the ICs is reduced. This increases the space inside the LCD display. In addition, the LCD display and the related signal processing method do not have to change the prior art display standard. In other words, the external circuit connected to the present invention LCD display does not have to be changed either. This also reduces the cost. Furthermore, because of the consistency of the hardware, the whole LCD display is more flexible for designers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display panel comprising:
a substrate;
a plurality of pixels formed on the substrate; and
a logic processing unit formed on the substrate for performing a calculation on a first gray value of an input data to form a second gray value of a display data.

2. The display of claim 1, wherein the logic processing unit comprises LTPS devices.

3. The display of claim 1, wherein the pixels are electro luminescent light emitting pixels.

4. The display of claim 1, wherein the pixels are organic electro luminescent light emitting pixels.

5. The display of claim 1, wherein the pixels are liquid crystal controlled light valves.

6. The display of claim 1, wherein the substrate is a glass substrate.

7. The display of claim 1, wherein the logic processing unit is an adder, and the calculation is an additive operation.

8. The display of claim 7, wherein the adder adds a predetermined number to the first gray value.

9. The display of claim 8, wherein the predetermined number is 1, −1, or 0.

10. The display of claim 1, further comprising:
a timing controller coupled to the logic processing unit for controlling the logic processing unit to perform the calculation.

11. A method for manufacturing a display panel comprising:
providing a substrate;
forming a plurality of pixels on the substrate; and
forming a logic processing unit on the substrate for performing a calculation on a first gray value of an input data to form a second gray value of a display data.

12. The method of claim 11, further comprising:
forming a timing controller for controlling the logic processing unit to perform the calculation.

13. The method of claim 11, wherein the step of forming the logic processing unit comprises utilizing a LTPS process to form the logic processing unit on the substrate.
